(19) United States
(12) Patent Application Publication
(10) Pub. No.: US 2024/0330661 A1
(43) Pub. Date: Oct. 3, 2024

(54) TECHNIQUES FOR GENERATING AND CORRECTING LANGUAGE MODEL OUTPUTS

(71) Applicant: VIANAI SYSTEMS, INC., Palo Alto, CA (US)

(72) Inventors: Walid RAHMAN, New York, NY (US); Maxwell K. BERGSTEIN, New York, NY (US); Tu TRUONG, San Jose, CA (US); Alex WILSON, Kenilworth, IL (US)

(21) Appl. No.: 18/621,593

(22) Filed: Mar. 29, 2024

Related U.S. Application Data
(60) Provisional application No. 63/493,693, filed on Mar. 31, 2023.

(51) Int. Cl. G06N 3/0475

(52) U.S. Cl. CPC G06N 3/0475

(57) ABSTRACT

One embodiment of a method for correcting a response generated by a machine learning model includes receiving the response from the machine learning model, where the response is generated by the machine learning model based on a request and a context, determining a plurality of portions of the context that are similar to one or more portions of the response, for each portion of the context included in the plurality of portions of the context, determining whether the portion of the context supports at least one portion of the response, and performing one or more operations to generate a corrected response based on the response and whether each portion of the context included in the plurality of portions of the context supports at least one portion of the response.

### CROSS-REFERENCE TO RELATED APPLICATIONS

This application claims priority benefit of the U.S. Provisional Patent Application titled, “TECHNIQUES FOR GENERATING AND CORRECTING LANGUAGE MODEL OUTPUTS,” filed on Mar. 31, 2023, and having Ser. No. 63/493,693. The subject matter of this related application is hereby incorporated herein by reference.

### BACKGROUND

### Field of the Various Embodiments

The embodiments of the present disclosure relate generally to the fields of computer science, machine learning, and artificial intelligence, and more specifically, to techniques for generating and correcting language model outputs.

### Description of the Related Art

Language models have become increasingly capable of performing various natural language processing tasks, such as question answering, sentiment analysis, and entity recognition. Large language models (LLMs) are one type of language model. Conventionally, an LLM is implemented as a neural network that includes a large number (e.g., billions) of parameters and is trained on a large quantity of text data. Once trained, an LLM can oftentimes perform a wide variety of natural language processing tasks, as opposed to only a specific task.

One drawback of conventional language models, and conventional LLMs in particular, is that these models sometimes generate outputs that are incorrect and/or incomplete. Incorrect outputs by LLMs are also referred to as “hallucinations.” For example, when prompted to respond to a request using information from text data that is provided as context, a conventional LLM can sometimes generate a response that contradicts the information in the context or does not include all of the relevant information in the context. As another example, a conventional LLM can sometimes not fully understand knowledge and terminology that is specific to a domain, and the LLM can respond to a request incorrectly as a result.

As the foregoing illustrates, what is needed in the art are more effective techniques for generating outputs using language models.

### SUMMARY

One embodiment of the present disclosure sets forth a computer-implemented method for correcting a response generated by a first machine learning model. The method includes receiving the response from the first machine learning model, where the response is generated by the first machine learning model based on a request and a context. The method further includes determining a plurality of portions of the context that are similar to one or more portions of the response. The method also includes, for each portion of the context included in the plurality of portions of the context, determining whether the portion of the context supports at least one portion of the response. In addition, the method includes performing one or more operations to generate a corrected response based on the response and whether each portion of the context included in the plurality of portions of the context supports at least one portion of the response.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques relative to the prior art is that the disclosed techniques can identify that a response generated by a language model is hallucinatory by being false and/or incorrect when compared to portions of a context used to generate the response. A hallucinatory response can be modified to be more accurate and/or to include more supporting information from the context. In addition, the disclosed techniques can identify a response as being incomplete when not all relevant portions of a context are included in the response. An incomplete response can be modified to include additional portions of the context that are relevant to a user request. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments;

FIG. 2 is a more detailed illustration of the natural language application of FIG. 1, according to various embodiments;

FIG. 3 is a more detailed illustration of the natural language application of FIG. 1, according to various other embodiments;

FIG. 4 is a flow diagram of method steps for generating a response to a user request using a language model, according to various embodiments;

FIG. 5 is a flow diagram of method steps for detecting and correcting an incorrect and/or incomplete response by a language model, according to various other embodiments; and

FIG. 6 is a flow diagram of method steps for detecting and correcting an incorrect and/or incomplete response by a language model, according to various other embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details.

### System Overview

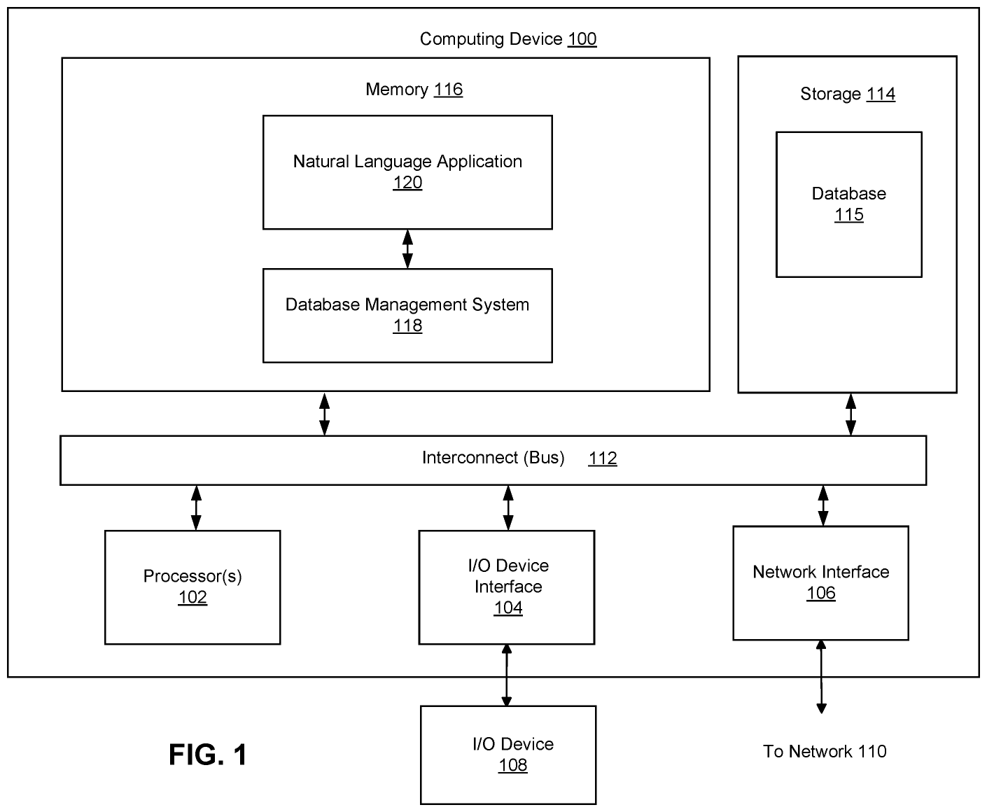

FIG. 1 illustrates a computing device 100 configured to implement one or more aspects of various embodiments. In some embodiments, computing device 100 can be a desktop computer, a laptop computer, a smart phone, a personal digital assistant (PDA), tablet computer, server machine, or any other type of computing device configured to receive input, process data, and optionally display images, and is suitable for practicing one or more embodiments of the present disclosure. As shown, computing device 100 is configured to run a natural language application 120 and a database management system 118 that resides in a memory 116 of computing device 100.

It is noted that computing device 100 described herein is illustrative and that any other technically feasible configurations fall within the scope of the present disclosure. For example, multiple instances of natural language application 120 and/or database management system 118 could execute on a set of nodes in a data center, cluster, or cloud computing environment to implement the functionality of computing device 100. In another example, natural language application 120 and/or database management system 118 could be implemented using any number of hardware and/or software components or layers.

As shown, computing device 100 includes, without limitation, an interconnect (bus) 112 that connects one or more processors 102, an input/output (I/O) device interface 104 coupled to one or more input/output (I/O) devices 108, memory 116, a storage 114 that stores a database 115, and a network interface 106. Processor(s) 102 may be any suitable processor(s) implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 can be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

In some embodiments, I/O devices 108 include devices capable of receiving input, such as a keyboard, a mouse, a touchpad, and/or a microphone, as well as devices capable of providing output, such as a display device and/or speaker. Additionally, I/O devices 108 can include devices capable of both receiving input and providing output, such as a touchscreen, a universal serial bus (USB) port, and so forth. The I/O devices 108 can be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In some embodiments, network 110 is any technically feasible type of communications network that allows data to be exchanged between computing device 100 and external entities or devices, such as a web server or another networked computing device. For example, network 110 could include a wide area network (WAN), a local area network (LAN), a wireless (WiFi) network, and/or the Internet, among others.

In some embodiments, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Natural language application 120 and database management system 118 can be stored in storage 114 and loaded into memory 116 when executed.

In some embodiments, memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including natural language application 120 and database management system 118.

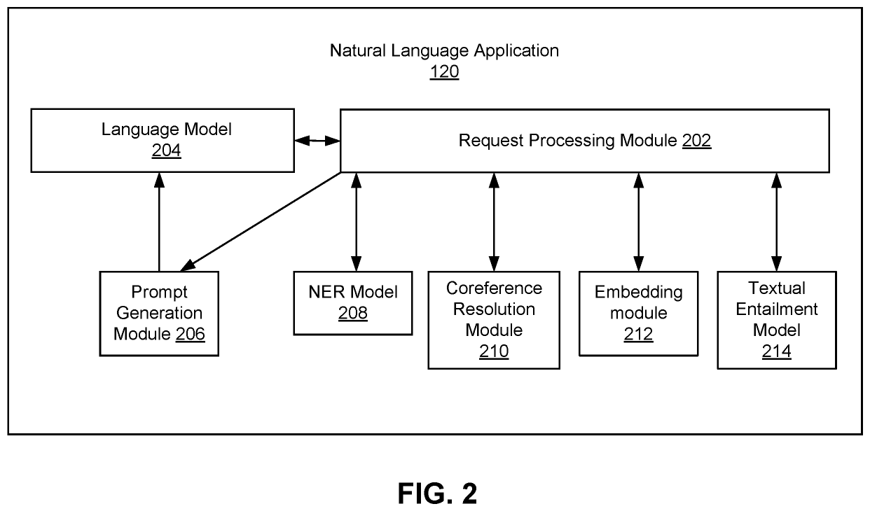

Database management system 118 is configured to store, retrieve, define, and manage data in database 115. In some embodiments, database management system 118 serves as an interface between database 115 and application programs, such as natural language application 120. In some embodiments, natural language application 120 is implemented to respond to user requests using a language model and one or more source documents. In such cases, natural language application 120 can identify relevant context information from the source documents, prompt the language model to generate a response using the context information, and progressively correct the response if necessary, as discussed in greater detail below in conjunction with FIGS. 2-6.

### Correcting Incorrect and Incomplete Responses of Language Models

FIG. 2 is a more detailed illustration of natural language application 120 of FIG. 1, according to various embodiments. As shown, in some embodiments, natural language application 120 includes, without limitation, a request processing module 202, a language model 204, a prompt generation module 206, a name entity recognition (NER) model 208, a coreference resolution module 210, an embedding module 212, and a textual entailment model 214.

Language model 204 is a machine learning model trained to perform one or more natural language processing tasks, such as question answering, summarization, and/or query generation. Any technically feasible language model 204 can be used in some embodiments, such as GPT (Generative Pre-trained Transformer), BERT (Bidirectional Encoder Representations from Transformers), Transformer, or the like. In some embodiments, language model 204 can be a large language model (LLM). Although language model 204 is shown as being included in natural language application 120, in some embodiments language model 204 can be external to natural language application 120. For example, in some embodiments, language model 204 can be executed in a cloud computing environment and accessible to natural language application 120 via an application programming interface (API). In the context of language models, prompts are used to guide the language model to generate responses and/or complete tasks. In some embodiments, prompt generation module 206 can, without limitation, generate a prompt that specifies a task to be performed, provides necessary context or background information, and/or controls the format and structure of output by language model 204. Although one language model 204 is shown for simplicity, in some embodiments, multiple language models can be used, such as different language models that are fine tuned for different tasks. For example, one or more of the prompts described herein can be used to prompt different language models. Prompt generation module 206 communicates with request processing module 202 to receive the task and context required to generate the prompt and inputs the generated prompt into language model 204 or returns the prompt to request processing module 202 for input into language model 204. After receiving the prompt as input, language model 204 outputs a response (e.g., an answer to a question).

As described, conventional language models, and LLMs in particular, sometimes generate outputs that are incorrect (i.e., “hallucinations”) and/or incomplete. In particular, when prompted to generate a response to a user request, such as an answer to a user question, using information from text data that is provided as context, a conventional language model can sometimes generate a response that contradicts the information in the context or does not include all of the relevant information in the context. To address this issue, in response to receiving a request, request processing module 202 identifies text data that is relevant to the request, prompts a language model 204 to generate a response to the request using information from the text data that is provided as context, and corrects the response generated by language model 204, if necessary.

In response to receiving a user request, request processing module 202 can identify text data that is relevant to the request in any technically feasible manner, such as using a keyword-based search to pull relevant documents from a database (not shown). After identifying relevant text data, request processing module 202 instructs prompt generation module 206 to generate a prompt that includes (1) text asking language model 204 to respond to the request, (2) the text data appended as context, and (3) text instructing language model 204 to only look for the response within the context. Prompt generation module 206 (or request processing module 202) then prompts language model 204 to generate a response using the generated prompt.

Oftentimes, responses generated by language model 204 can include inherent ambiguities. For example, pronouns such as “he”, “she”, “it” can refer to multiple different nouns, and an entity can be described in various ways across a text (e.g., “president of the United States”, “he”). In some embodiments, to address such ambiguities, request processing module 202 can (1) identify entities (e.g., companies, persons, locations, etc.) within a response generated by language model 204 using an NER model 208, and (2) ask coreference resolution module 210 to perform coreference resolution, which resolves ambiguous references within the response by understanding the relationships between entities in the response. NER model 208 can identify and classify named entities in a text into predefined categories. Named entities are real-world objects, such as persons, organizations, locations, etc. Request processing module 202 provides the response generated by language model 204 to NER model 208 in order to find named entities that can be used by coreference resolution module 210 to resolve ambiguous references in the response. Given the response and name entities as inputs, coreference resolution module 210 generates a resolved response. In some embodiments, NER model 208 and coreference resolution module 210 are used to iteratively process different portions of the response.

In some embodiments, request processing module 202 can use embedding module 212 to generate an embedding that is a compressed representation that captures semantic properties of the response. Embedding module 212 generates a compressed representation of text in the response in which words, phrases, and the entire text are mapped to the embedding, which can be a vector of numbers. Using the embedding, request processing module 202 can perform an embedding search for each portion of the response to identify the top N most similar portions of context, for which embeddings were previously generated, to that portion of the response. For example, in some embodiments, the portions of the response can be sentences from the response, and the portions of the context can be sentences from the context. Any technically feasible similarity metric can be used to identify the top N most similar portions of the context, for example, a Cosine similarity with a value higher than a predefined threshold can be used to identify the N most similar portions of the context whose similarity values are above the threshold. Although described herein primarily with respect to the top N most similar portions of the context for simplicity, it should be noted that if less than N portions of the contexts are within the threshold of similarity, then less than N most similar portions of the context can be used. In some embodiments, embeddings of portions of the context can also be stored in database 115 for improved retrieval time.

In some other embodiments, rather than performing the embedding searches, described above, request processing module 202 can prompt language model 204 to identify the top N most similar portions (e.g., sentences) of the context to each portion (e.g., sentence) of the response.

In some embodiments, to correct a response generated by language model 204, request processing module 202 (1) instructs prompt generation module 206 to generate a text prompt that is input into language model 204 to augment each portion of the response, (2) computes an entailment score for each portion of the response and each augmented portion of the response that indicates whether the portion of the response or the augmented portion of the response aligns or conflicts with each of the N most similar portions of the context, (3) computes a hallucination score using the computed entailment scores, and (4) modifies the response based on the entailment scores that are computed for portions of response and augmented portions of the response. Textual entailment refers to a relationship between two text fragments indicating whether the truth of one text fragment can be inferred from the other text fragment. Two text fragments can support (i.e., entail) each other, contradict each other, or be neutral. A value can be assigned to indicate the extent of the relationship between two text fragments, which is referred to herein as the entailment score. Textual entailment model 214 is trained to compute an entailment score between a portion of the response or an augmented portion of the response and a portion of the context. For example, if textual entail model 214 generates, for a negated portion in the response and a portion of context, a higher entailment score than textual entail model 214 generates for the portion of response and the portion of context, then the response of the language model 204 conflicts with the portion of context, and vice versa if the original portion of the response is associated with a higher entailment score than the negated portion of the response.

For example, in some embodiments, the augmentation can include negating each portion of the response, such as negating sentences from the response. In some embodiments, request processing module 202 can ask prompt generation module 206 to generate prompts that are input into language model 204 (or another machine learning model that is fine tuned for generating negations) to generate negations of the portions of the response. For example, language model 204 could add the word not and/or any other phrase that generates the opposite meaning of the portions of the response.

If request processing module 202 determines multiple portions of context are relevant to a portion of the response, then the entailment score for each portion of context and augmented portion of response is calculated separately. In addition, one or more portions of context that request processing module 202 uses to determine that a particular portion of the response is hallucinatory can be used to correct the particular portion of the response by, for example, prompting language model 204 to correct the particular portion of the response using the one or more portions of context.

In some embodiments, request processing module 202 also checks whether each portion of the context that is relevant to the user request is within the response to identify any relevant portions of context that are not within the response, indicating that the response is incomplete. In such cases, request processing module 202 can prompt language model 204 to add the portion(s) of context that are relevant to the user request to the response.

The request processing module 202 can modify the response of language model 204 in any suitable manner based on the computed entailment scores for each portion of the context and each augmented portion, and/or based on whether each portion of the context is within the response. For example, in some embodiments, request processing module 202 can compute a total hallucination score by summing the number of portions of the response that are potentially hallucinatory, as indicated by the entailment score for the negation of those portions of the response with respect to any relevant portion of the context being higher than the entailment score for those portion of the response, and dividing by the total number of portions of the response. If the hallucination score is above a threshold, request processing module 202 can prompt language model 204 to modify the potentially hallucinatory portions of the response, thereby generating a new response. The new response can then be processed in the same manner, until a response is generated for which the hallucination score is not above the threshold.

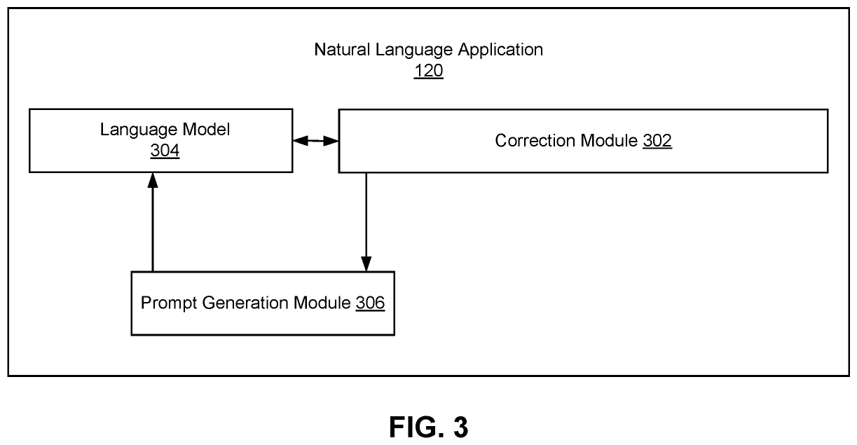

FIG. 3 is a more detailed illustration of natural language application 120 of FIG. 1, according to various other embodiments. As shown, natural language application 120 includes, without limitation, a request processing module 302, a language model 304, and a prompt generation module 306. Language model 304 and prompt generation module 306 are similar to language model 204 and prompt generation module 206, respectively, described above in conjunction with FIG. 3. Although language model 304 is shown as being included in natural language application 120, in some embodiments language model 304 can be external to natural language application 120. For example, in some embodiments, language model 304 can be executed in a cloud computing environment and accessible to natural language application 120 via an API. Although one language model 304 is shown for simplicity, in some embodiments, multiple language models can be used, such as different language models that are fine tuned for different tasks.

Similar to request processing module 202, in response to receiving a user request, request processing module 302 can identify text data that is relevant to the request in any technically feasible manner, such as using a keyword-based search to pull relevant documents from a database (not shown). After identifying relevant text data, request processing module 302 instructs prompt generation module 306 to generate a prompt that includes (1) text asking language model 304 to respond to the request, (2) the text data appended as context, and (3) text instructing language model 304 to only look for the response within the context. Prompt generation module 306 (or request processing module 302) then prompts language model 304 to generate a response using the generated prompt.

In some embodiments, for each of a number (M) of portions of the context that are relevant to the response (e.g., that are most similar as determined using an embedding search or by prompting language model 304 to identify the most similar portions of the context), request processing module 302 instructs prompt generation module 306 to generate text prompts to prompt language model 304 multiple (N) (e.g., five) times whether the response agrees or disagrees with that portion of context. In some embodiments, the relevant portions of the context can be chunks from the context of a given length (e.g., a number of tokens). In some embodiments, the prompts can be generated with different parameters, such as different temperature settings for the language model 304. In some embodiments, the multiple prompts of language model 304 can occur in parallel. The language model 304 then responds the number of times whether the response agrees or disagrees with each portion of the context.

Thereafter, request processing module 302 computes a hallucination score for each relevant portion of the context based on a sum of the number of times that language model 304 determined that the response is hallucinatory with respect to that portion of context. Request processing module 302 then checks whether the hallucination score is above a threshold. For example, if three times out of five times language model 302 determines that a portion of context disagrees with the response, the hallucination score would be sixty percent, which could indicate that the response is hallucinatory with respect to the portion of context if the threshold is fifty percent.

The request processing module 302 can modify the response of language model 304 in any suitable manner based on the computed hallucination score. In some embodiments, request processing module 302 can instruct prompt generation module 306 to generate yet another prompt which includes each portion of the context along with an indication of whether the portion is determined to be hallucinatory or otherwise notable. The prompt further instructs language model 304 to rewrite the response for each hallucinatory portion of the context.

After the response has been rewritten to better agree with each of the portions of the context that the response did not previously agree with, request processing module 302 instructs prompt generation module 306 to generate a prompt to summarize all of the rewritten responses while ensuring that information in the rewritten responses is preserved in the summarized response. Request processing module 302 then prompts language model 304 to check whether the summarized response is hallucinatory with respect to any portions of the context using the same process, described above, and continues to modify the summarized response, if necessary, until a summarized response is generated that is not hallucinatory with respect to any portions of the context.

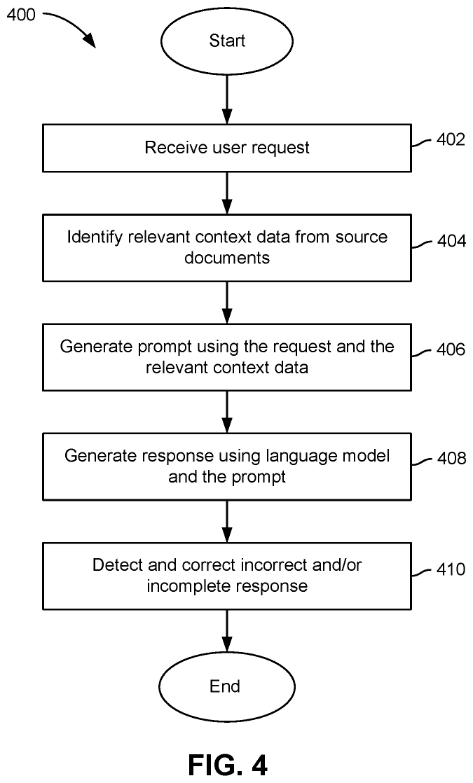

FIG. 4 is a flow diagram of method steps for generating a response to a user request using a language model, according to various embodiments. Although the method steps are described in conjunction with FIGS. 1-3, persons skilled in the art will understand that any system configured to perform the method steps, in any order, falls within the scope of the present disclosure.

As shown, a method 400 begins at step 402, where natural language application 120 receives a request from a user. Any suitable user request that includes text, such as a question from the user, can be received in some embodiments.

At step 404, natural language application 120 identifies relevant text data from source documents. In some embodiments, natural language application 120 can identify relevant text data to a user request in any technically feasible manner, such as using a keyword-based search to pull relevant documents from a database or any other source document(s).

At step 406, natural language application 120 (specifically, prompt generation module 206) generates a natural language prompt using the user request and relevant context data. In some embodiments, the prompt can include (1) text asking a language model to respond to the request, (2) the text data identified at step 404 appended as context, and (3) text indicating that the language model should only look for the response within the context.

At step 408, natural language application 120 prompts the language model to generate a response using the prompt generated at step 406.

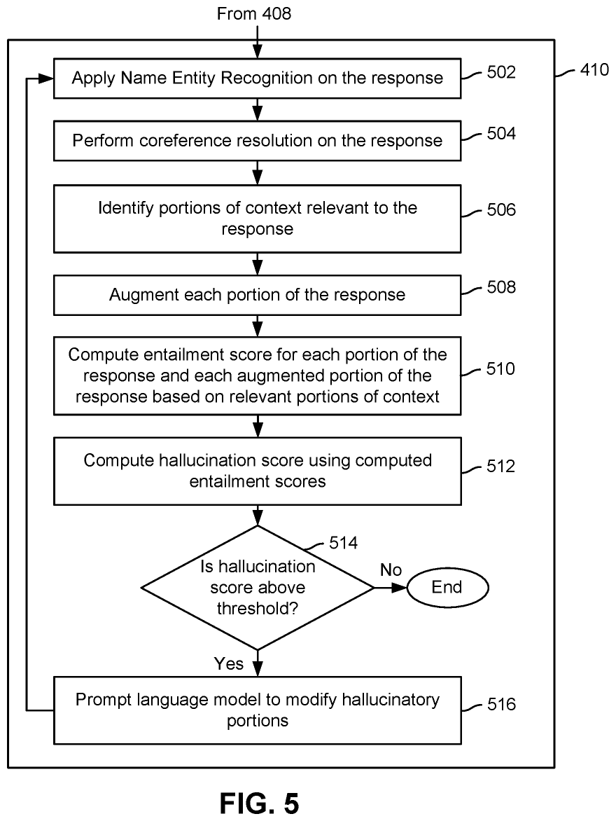

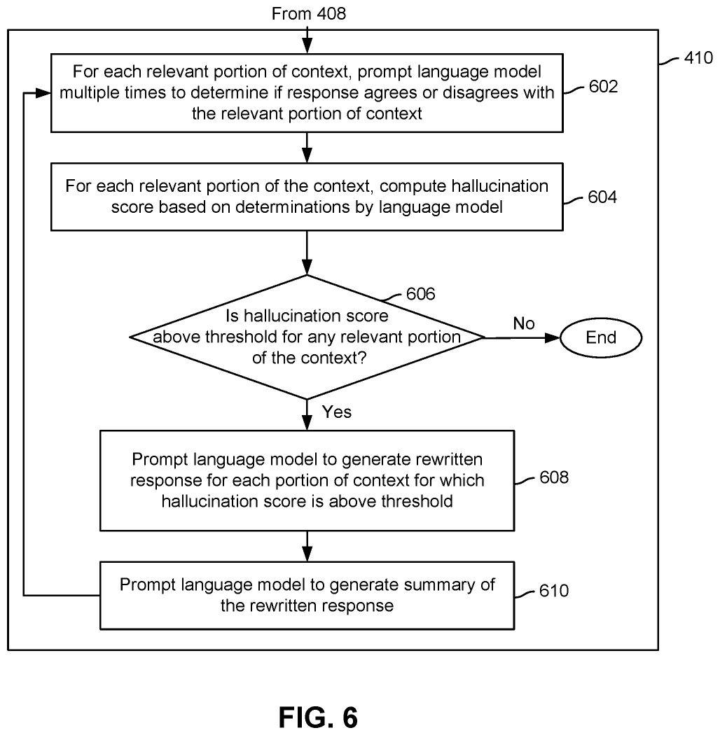

At step 410, natural language application 120 detects and corrects an incorrect and/or incomplete response. In some embodiments, natural language application 120 detects conflicts (hallucinations) between one or more portions of the response and one or more portions of the context, and natural language application 120 corrects the hallucinations in the response, as discussed in greater detail below in conjunction with FIGS. 5-6. In some embodiments, natural language application 120 also checks whether each portion of the context relevant to the user request is within the response to identify any portions of context that are not within the response, indicating that the response is incomplete. In such cases, natural application 120 can prompt the language model to add the portion(s) of context that are relevant to the user request to the response.

FIG. 5 is a flow diagram of method steps for detecting and correcting an incorrect and/or incomplete response by a language model, according to various embodiments. Although the method steps are described in conjunction with FIGS. 1-3, persons skilled in the art will understand that any system configured to perform the method steps, in any order, falls within the scope of the present disclosure.

As shown, at step 502, natural language application 120 applies name entity recognition on the response generated by the language model at step 408 to identify entities in the response. In some embodiments, natural language application 120 can identify entities (e.g., companies, persons, locations, etc.) within the response of the language model 204 using a NER model (e.g., NER model 208).

At step 504, natural language application 120 performs coreference resolution on the response with the identified entities at step 502. Coreference resolution resolves ambiguous references by understanding the relationships between entities in the response.

At step 506, natural language application 120 identifies portions of the context, determined at step 404, that are relevant to the response. In some embodiments, natural language application 120 performs an embedding search for each portion (e.g., sentence) of the response to identify the top N most similar portions of the context to each portion of the response. Any technically feasible similarity metric can be used to identify the top N most similar portions of the context, such as Cosine similarity, with the N most similar portions of the context having a Cosine similarity value that is higher than a threshold. In some other embodiments, natural language application 120 prompts the language model to identify the top N most similar portions of the context to each portion of the response.

At step 508, natural language application 120 augments each portion of the response. In some embodiments, natural language application 120 prompts the language model to augment each portion (e.g., sentence) of the response. For example, in some embodiments, the augmentation can include negating the portions of the response, such as negating sentences from the response. In some embodiments, natural language application 120 can prompt language model 204 to negate the portions of the response. For example, language model 204 can add the word not and/or any other phrase that generates the opposite meaning of each sentence in the response.

At step 510, natural language application 120 uses a textual entailment model to compute an entailment score for each portion of the response and each augmented portion of the response based on the corresponding relevant portions of the context determined at step 506. For example, if a negated portion in the response is associated with a higher entailment score than the corresponding portion of the response is, then the response of the language model 204 conflicts with the portion of the context and is potentially hallucinatory, and vice versa if the corresponding portion of the response is associated with a higher entailment score than the negated portion of the response, which can be reflected in the entailment scores that are computed for the portion of the response and the negated portion of the response.

At step 512, natural language application 120 computes a hallucination score for the response using the computed entailment scores for each portion of the response. In some embodiments, natural language application 120 computes the hallucination score by summing the number of portions of the response that are potentially hallucinatory, as indicated by the entailment scores for the negations of those portions of the response being higher than the entailment scores for those portion of the response for any relevant portions of the context, and dividing by the total number of portions of the response.

At step 514, natural language application 120 determines if the hallucination score is above a threshold. If the hallucination score is not above the threshold, then method 400 ends.

On the other hand, if the hallucination score is above the threshold, then method 400 continues to step 516, where natural language application 120 prompts the language model to modify the potentially hallucinatory portions of the response to better match the corresponding relevant portions of context, thereby generating a new response. Method 400 then returns to step 502, where natural language application 120 applies name entity recognition on the new response.

FIG. 6 is a flow diagram of method steps for detecting and correcting an incorrect and/or incomplete response by a language model, according to various other embodiments. Although the method steps are described in conjunction with FIGS. 1-3, persons skilled in the art will understand that any system configured to perform the method steps, in any order, falls within the scope of the present disclosure.

As shown, at step 602, natural language application 120 prompts a language model multiple times for each of a number (e.g., M) of relevant portions of the context to determine if the response generated at step 408 agrees or disagrees with the relevant portion of the context. In some embodiments, the relevant portions of the context are portions of the context that are most similar to the entire response, as identified via an embedding search or by prompting the language model to identify the most similar portions, similar to step 506, described above in conjunction with FIG. 5. In some embodiments, each relevant portion of the context can include a chunk of the context having a particular size. In some embodiments, the multiple prompts can be generated with different parameters, such as different temperature settings for the language model, and executed in parallel. After receiving the multiple prompts, the language model responds a number of times whether the response agrees or disagrees with each relevant portion of the context.

At step 604, for each relevant portion of the context, natural language application 120 computes a hallucination score for the response based on the determinations by the language model at step 602. In some embodiments, request processing module 302 computes the hallucination score for each portion of the context as a sum of the number of times that the language model determined that the response is hallucinatory with respect to the portion of context.

At step 606, natural language application 120 checks whether the hallucination score is above a threshold for any relevant portion of the context. For example, if three times out of five times language model 304 determines that a portion of context disagrees with the response, the hallucination score would be sixty percent, which could indicate that the response is hallucinatory with respect to the portion of context if the threshold is fifty percent.

If natural language application 120 determines that the hallucination score is not above the threshold for any relevant portion of the context, then method 300 ends. On the other hand, if natural language application 120 determines that the hallucination score is above the threshold for any relevant portion of the context, then method 300 continues to step 608, where natural language application 120 prompts the language model to generate a rewritten response for each portion of context for which the hallucination score is above the threshold. In some embodiments, natural language application 120 can prompt language model 304 to rewrite the response to better match each portion of the context for which the hallucination score is above the threshold.

At step 610, natural language application 120 prompts the language model to generate a summary of the rewritten responses. The summary can then be used as a new response. In some embodiments, the prompt to summarize the rewritten responses can ask the language model to ensure the information from all of the rewritten responses is preserved in the summary. Method 300 then returns to step 602, where natural language application 120 again prompts the language model multiple times for each relevant portion of the context to determine if the response (i.e., the summary generated at step 610) agrees or disagrees with the relevant portion of context.

In sum, a natural language application generates and corrects responses to user requests using a language model. In some embodiments, the natural language application identifies context data from documents and/or other sources that are relevant to the user request. Then, the natural language application generates a prompt that includes the user request, the identified context data, and an instruction for a language model to respond to the request using information in the context data. The natural language application can employ two different techniques to detect incorrect and incomplete responses generated by the language model and correct such responses. In some embodiments, after resolving ambiguous entities in the response, the natural language application can (1) identify portions of the context that are relevant to portions of the response using an embedding search, and (2) generate augmented portions of the response. In such cases, the natural language application computes an entailment score for each portion of the response and each relevant portion of the context, as well as for each augmented portion of response and each relevant portion of the context. The computed entailment scores are used to compute a hallucination score for the response based on whether the portions of response or the negations of the portions of the response are a better match to the relevant portions of the context. If the hallucination score is above a threshold, the natural language application prompts the language model to modify the response to better match relevant portions of the context for which the entailment score of a negated portion of the response is higher than the entailment score for the portion of the response. The natural language application can also check whether each portion of the context is within the response to identify any portions of context that are not within the response and then prompt the language model to add the identified portions of context to the response. In some other embodiments, the natural language application can prompt a language model multiple times to determine if the response agrees or disagrees with relevant portions of the context used to generate the response. Then, the natural language application computes a hallucination score for each relevant portion of the context based on the number of times the language model determines that the response agrees or disagrees with the relevant portion of the context. If the hallucination score is above a threshold for any relevant portion of the context, the natural language application prompts the language model to rewrite the response for each portion of the context associated with a hallucination score that is above the threshold. The natural language application then prompts the language model to summarize the rewritten responses to generate a new response and repeats the above steps for the new response until the hallucination scores computed for all relevant portions of context are below the threshold.

One technical advantage of the disclosed techniques relative to the prior art is that the disclosed techniques can identify that a response generated by a language model is hallucinatory by being false and/or incorrect when compared to portions of a context used to generate the response. A hallucinatory response can be modified to be more accurate and/or to include more supporting information from the context. In addition, the disclosed techniques can identify a response as being incomplete when not all relevant portions of a context are included in the response. An incomplete response can be modified to include additional portions of the context that are relevant to a user request. These technical advantages provide one or more technological improvements over prior art approaches.

1. In some embodiments, a computer-implemented method for correcting a response generated by a first machine learning model comprises receiving the response from the first machine learning model, wherein the response is generated by the first machine learning model based on a request and a context, determining a plurality of portions of the context that are similar to one or more portions of the response, for each portion of the context included in the plurality of portions of the context, determining whether the portion of the context supports at least one portion of the response, and performing one or more operations to generate a corrected response based on the response and whether each portion of the context included in the plurality of portions of the context supports at least one portion of the response.

2. The computer-implemented method of clause 1, wherein, for each portion of the context included in the plurality of portions of the context, determining whether the portion of the context supports at least one portion of the response comprises prompting a second machine learning model a plurality of times to generate a plurality of determinations of whether the portion of the context supports the at least one portion of the response, and determining whether the portion of the context supports the at least one portion of the response based on the plurality of determinations.

3. The computer-implemented method of clauses 1 or 2, wherein performing one or more operations to generate the corrected response comprises for each portion of the context included in the plurality of portions of the context that does not support at least one portion of the response, prompting the second machine learning model to generate an intermediate corrected response based on the portion of the context, and prompting the second machine learning model to generate the corrected response based on the intermediate corrected response generated for each portion of the context included in the plurality of portions of the context that does not support at least one portion of the response.

4. The computer-implemented method of any of clauses 1-3, wherein the first machine learning model is the second machine learning model.

5. The computer-implemented method of any of clauses 1-4, wherein, for each portion of the context included in the plurality of portions of the context, determining whether the portion of the context supports at least one portion of the response comprises performing one or more operations to compute a first entailment of the at least one portion of the response by the portion of the context, performing one or more operations to compute a second entailment of a negation of the at least one portion of the response by the portion of the context, and determining whether the portion of the context supports the at least one portion of the response based on the first entailment and the second entailment.

6. The computer-implemented method of any of clauses 1-5, further comprising performing one or more coreference resolution operations on the one or more portions of the response.

7. The computer-implemented method of any of clauses 1-6, wherein the plurality of portions of the context are determined to be similar to the one or more portions of the response based on semantic similarity.

8. The computer-implemented method of any of clauses 1-7, wherein each portion of context included in the plurality of portions of the context is a sentence, and each portion of the response included in the one or more portions of the response is a sentence.

9. The computer-implemented method of any of clauses 1-8, wherein each portion of context included in the plurality of portions of the context includes text of a predefined length, and the one or more portions of the response includes an entirety of the response.

10. The computer-implemented method of any of clauses 1-9, wherein the first machine learning model comprises a large language model (LLM).

11. In some embodiments, one or more non-transitory computer-readable media store instructions that, when executed by at least one processor, cause the at least one processor to perform the steps of receiving a response from a trained first machine learning model, wherein the response is generated by the first machine learning model based on a request and a context, determining a plurality of portions of the context that are similar to one or more portions of the response, for each portion of the context included in the plurality of portions of the context, determining whether the portion of the context supports at least one portion of the response, and performing one or more operations to generate a corrected response based on the response and whether each portion of the context included in the plurality of portions of the context supports at least one portion of the response.

12. The one or more non-transitory computer-readable media of clause 11, wherein, for each portion of the context included in the plurality of portions of the context, determining whether the portion of the context supports at least one portion of the response comprises prompting a second machine learning model a plurality of times to generate a plurality of determinations of whether the portion of the context supports the at least one portion of the response, and determining whether the portion of the context supports the at least one portion of the response based on the plurality of determinations.

13. The one or more non-transitory computer-readable media of clauses 11 or 12, wherein performing one or more operations to generate the corrected response comprises for each portion of the context included in the plurality of portions of the context that does not support at least one portion of the response, prompting the second machine learning model to generate an intermediate corrected response based on the portion of the context, and prompting the second machine learning model to generate the corrected response based on the intermediate corrected response generated for each portion of the context included in the plurality of portions of the context that does not support at least one portion of the response.

14. The one or more non-transitory computer-readable media of any of clauses 11-13, wherein the first machine learning model is the second machine learning model.

15. The one or more non-transitory computer-readable media of any of clauses 11-14, wherein, for each portion of the context included in the plurality of portions of the context, determining whether the portion of the context supports at least one portion of the response comprises performing one or more operations to compute a first entailment of the at least one portion of the response by the portion of the context, performing one or more operations to compute a second entailment of a negation of the at least one portion of the response by the portion of the context, and determining whether the portion of the context supports the at least one portion of the response based on the first entailment and the second entailment.

16. The one or more non-transitory computer-readable media of any of clauses 11-15, wherein the instructions, when executed by the at least one processor, further cause the at least one processor to perform the step of performing one or more coreference resolution operations on the one or more portions of the response.

17. The one or more non-transitory computer-readable media of any of clauses 11-16, wherein the instructions, when executed by the at least one processor, further cause the at least one processor to perform the steps of determining the context based on the request, and prompting the first machine learning model to generate the response based on the request and the context.

18. The one or more non-transitory computer-readable media of any of clauses 11-17, wherein performing one or more operations to generate the corrected response comprises computing a score based on whether each portion of the context included in the plurality of portions of the context supports at least one portion of the response, and appending the score to the response.

19. The one or more non-transitory computer-readable media of any of clauses 11-18, wherein the instructions, when executed by the at least one processor, further cause the at least one processor to perform the steps of searching a database based on the request to determine the context, wherein the context includes at least one portion of one or more documents stored in the database, and prompting the first machine learning model to generate the response based on the request and the context.

20. In some embodiments, a system comprises one or more memories storing instructions, and one or more processors that are coupled to the one or more memories and, when executing the instructions, are configured to receive a response from a trained machine learning model, wherein the response is generated by the machine learning model based on a request and a context, determine a plurality of portions of the context that are similar to one or more portions of the response, for each portion of the context included in the plurality of portions of the context, determine whether the portion of the context supports at least one portion of the response, and perform one or more operations to generate a corrected response based on the response and whether each portion of the context included in the plurality of portions of the context supports at least one portion of the response.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for correcting a response generated by a first machine learning model, the method comprising:
receiving the response from the first machine learning model, wherein the response is generated by the first machine learning model based on a request and a context;
determining a plurality of portions of the context that are similar to one or more portions of the response;
for each portion of the context included in the plurality of portions of the context, determining whether the portion of the context supports at least one portion of the response; and
performing one or more operations to generate a corrected response based on the response and whether each portion of the context included in the plurality of portions of the context supports at least one portion of the response.

2. The computer-implemented method of claim 1, wherein, for each portion of the context included in the plurality of portions of the context, determining whether the portion of the context supports at least one portion of the response comprises:
prompting a second machine learning model a plurality of times to generate a plurality of determinations of whether the portion of the context supports the at least one portion of the response; and
determining whether the portion of the context supports the at least one portion of the response based on the plurality of determinations.

3. The computer-implemented method of claim 2, wherein performing one or more operations to generate the corrected response comprises:
for each portion of the context included in the plurality of portions of the context that does not support at least one portion of the response, prompting the second machine learning model to generate an intermediate corrected response based on the portion of the context; and
prompting the second machine learning model to generate the corrected response based on the intermediate corrected response generated for each portion of the context included in the plurality of portions of the context that does not support at least one portion of the response.

4. The computer-implemented method of claim 2, wherein the first machine learning model is the second machine learning model.

5. The computer-implemented method of claim 1, wherein, for each portion of the context included in the plurality of portions of the context, determining whether the portion of the context supports at least one portion of the response comprises:
performing one or more operations to compute a first entailment of the at least one portion of the response by the portion of the context;
performing one or more operations to compute a second entailment of a negation of the at least one portion of the response by the portion of the context; and
determining whether the portion of the context supports the at least one portion of the response based on the first entailment and the second entailment.

6. The computer-implemented method of claim 1, further comprising performing one or more coreference resolution operations on the one or more portions of the response.

7. The computer-implemented method of claim 1, wherein the plurality of portions of the context are determined to be similar to the one or more portions of the response based on semantic similarity.

8. The computer-implemented method of claim 1, wherein each portion of context included in the plurality of portions of the context is a sentence, and each portion of the response included in the one or more portions of the response is a sentence.

9. The computer-implemented method of claim 1, wherein each portion of context included in the plurality of portions of the context includes text of a predefined length, and the one or more portions of the response includes an entirety of the response.

10. The computer-implemented method of claim 1, wherein the first machine learning model comprises a large language model (LLM).

11. One or more non-transitory computer-readable media storing instructions that, when executed by at least one processor, cause the at least one processor to perform the steps of:
receiving a response from a trained first machine learning model, wherein the response is generated by the first machine learning model based on a request and a context;
determining a plurality of portions of the context that are similar to one or more portions of the response;
for each portion of the context included in the plurality of portions of the context, determining whether the portion of the context supports at least one portion of the response; and
performing one or more operations to generate a corrected response based on the response and whether each portion of the context included in the plurality of portions of the context supports at least one portion of the response.

12. The one or more non-transitory computer-readable media of claim 11, wherein, for each portion of the context included in the plurality of portions of the context, determining whether the portion of the context supports at least one portion of the response comprises:
prompting a second machine learning model a plurality of times to generate a plurality of determinations of whether the portion of the context supports the at least one portion of the response; and
determining whether the portion of the context supports the at least one portion of the response based on the plurality of determinations.

13. The one or more non-transitory computer-readable media of claim 12, wherein performing one or more operations to generate the corrected response comprises:
for each portion of the context included in the plurality of portions of the context that does not support at least one portion of the response, prompting the second machine learning model to generate an intermediate corrected response based on the portion of the context; and
prompting the second machine learning model to generate the corrected response based on the intermediate corrected response generated for each portion of the context included in the plurality of portions of the context that does not support at least one portion of the response.

14. The one or more non-transitory computer-readable media of claim 12, wherein the first machine learning model is the second machine learning model.

15. The one or more non-transitory computer-readable media of claim 11, wherein, for each portion of the context included in the plurality of portions of the context, determining whether the portion of the context supports at least one portion of the response comprises:
performing one or more operations to compute a first entailment of the at least one portion of the response by the portion of the context;
performing one or more operations to compute a second entailment of a negation of the at least one portion of the response by the portion of the context; and
determining whether the portion of the context supports the at least one portion of the response based on the first entailment and the second entailment.

16. The one or more non-transitory computer-readable media of claim 11, wherein the instructions, when executed by the at least one processor, further cause the at least one processor to perform the step of performing one or more coreference resolution operations on the one or more portions of the response.

17. The one or more non-transitory computer-readable media of claim 11, wherein the instructions, when executed by the at least one processor, further cause the at least one processor to perform the steps of:
determining the context based on the request; and
prompting the first machine learning model to generate the response based on the request and the context.

18. The one or more non-transitory computer-readable media of claim 11, wherein performing one or more operations to generate the corrected response comprises:
computing a score based on whether each portion of the context included in the plurality of portions of the context supports at least one portion of the response; and
appending the score to the response.

19. The one or more non-transitory computer-readable media of claim 11, wherein the instructions, when executed by the at least one processor, further cause the at least one processor to perform the steps of:
searching a database based on the request to determine the context, wherein the context includes at least one portion of one or more documents stored in the database; and
prompting the first machine learning model to generate the response based on the request and the context.

20. A system, comprising:
one or more memories storing instructions; and
one or more processors that are coupled to the one or more memories and, when executing the instructions, are configured to:
receive a response from a trained machine learning model, wherein the response is generated by the machine learning model based on a request and a context,
determine a plurality of portions of the context that are similar to one or more portions of the response,
for each portion of the context included in the plurality of portions of the context, determine whether the portion of the context supports at least one portion of the response, and
perform one or more operations to generate a corrected response based on the response and whether each portion of the context included in the plurality of portions of the context supports at least one portion of the response.
